(19) United States
(12) Patent Application Publication
(10) Pub. No.: US 2013/0335236 A1
(43) Pub. Date: Dec. 19, 2013

(54) ALL TERRAIN VEHICLE SIGNALING APPARATUS

(71) Applicant: Tom Tippets, Yerington, NV (US)

(72) Inventor: Tom Tippets, Yerington, NV (US)

(21) Appl. No.: 13/527,363

(22) Filed: Jun. 19, 2012

(51) Int. Cl. G08G 1/00

(52) U.S. Cl. 340/902

(57) ABSTRACT

The present technology provides a communication system which allows a first operator of a vehicle to signal an operator of a second vehicle. The first operator may transmit a notification signal via a first transceiver to a second transceiver associated with the second operator with a specific message, such as “stop.” When the second transceiver receives the notification signal, a visual indicator may be provided to the operator of the second vehicle. The second transceiver may also automatically transmit a confirmation signal upon receiving the notification signal. By receiving the notification signal, the first user may be informed that the notification signal was received by the second transceiver. By providing for a notification signal and an automated confirmation signal in response, the present system informs the first user the confidence that his transmitted signal was received.

### BACKGROUND

Operating all terrain vehicles (ATVs) in an off-road environment has become a popular activity. Typically, two or more users operate their all terrain vehicles in an all-terrain environment, traveling over obstacles and traversing a landscape. The all terrain environment obstacles may include hills, trees, and other objects, which often times prevent the ATV users from seeing or communicating with each other while in the environment. Additionally, the nature of operating an ATV often involves rough environments and tough conditions, resulting in wear and tear on the ATVs.

It is not uncommon for an ATV to become damaged, requiring the user of the ATV to slow down or stop traveling on her ATV. Because of the nature of typical all terrain environments, users of ATVs may not always be in sight or sound of each other while in the environment. Therefore, it can be difficult for a user of a first ATV to communicate with a user of a second ATV, especially when one user has stopped while the user of another ATV continues onward. What is needed is an improved method of communication between users of ATVs.

### SUMMARY

The present technology provides a communication system which allows a first operator of a vehicle to signal an operator of a second vehicle. The first operator may transmit a notification signal via a first transceiver to a second transceiver associated with the second operator with a specific message, such as “stop.” When the second transceiver receives the notification signal, a visual indicator may be provided to the operator of the second vehicle. The second transceiver may also automatically transmit a confirmation signal upon receiving the notification signal. By receiving the notification signal, the first user may be informed that the notification signal was received by the second transceiver. By providing for a notification signal and an automated confirmation signal in response, the present system informs the first user the confidence that his transmitted signal was received. The present technology may be used for any type of vehicle, including all terrain vehicles (ATV), snow mobiles, jet skis, and other vehicles.

An embodiment may include a method for communicating a fixed signal. An input may be received by a first transceiver associated with a first vehicle to transmit a notification signal. The notification signal may be transmitted by the first transceiver. A confirmation signal may be received from a second transceiver. The second transceiver may be associated with a second user of a second vehicle. The confirmation signal may be transmitted by the second transceiver in response to receiving the notification signal. A visual indicator may be provided by the first transceiver based on the confirmation signal.

An embodiment may include a transceiver having an antenna, an input, a visual indicator and circuitry. The antenna may transmit and receive a radio frequency signal. The input may receive a user input. The circuitry may be coupled to the antenna, input component, and the visual indicator. The circuitry may receive an input signal from the input component, encode a notification signal based on the received input signal, transmit the notification signal through the antenna, process a confirmation signal received through the antenna, and illuminate the visual indicator based on the received confirmation signal.

An embodiment may include a method for communicating a fixed signal. A notification signal may be received by a first transceiver associated with a first vehicle from a second transceiver associated with a second vehicle. An LED may be illuminated by the first transceiver in response to receiving the notification signal. A confirmation signal may be transmitted by the first transceiver associated with a first vehicle to the second transceiver associated with a second vehicle.

An embodiment may include a transceiver for communicating a fixed signal. The transceiver may include an antenna, an input component, a visual indicator and circuitry. The antenna may transmit and receive a radio frequency signal and the input may receive input from a user. The circuitry may be coupled to the antenna, input component, and the visual indicator, the may decode a notification signal received from the antenna. The circuitry may also illuminate the visual indicator based on the decoded notification signal and provide an encoded confirmation signal to the antenna for transmission through the antenna.

### BRIEF DESCRIPTION OF FIGURES

FIG. 1 illustrates an exemplary all terrain vehicle environment.

FIG. 2 is a block diagram of exemplary communications between two transceiver devices.

FIG. 3 is a block diagram of an exemplary transceiver device.

FIG. 4 is an exemplary transceiver.

FIG. 5 is a flow chart of an exemplary method for transmitting a notification signal by a transceiver from a first vehicle.

FIG. 6 is a flow chart of an exemplary method for transmitting a confirmation signal from a second vehicle.

FIG. 7 is a flow chart of an exemplary method for automatically transmitting a hazard signal.

### DETAILED DESCRIPTION

The present technology provides a communication system which allows a first operator of a vehicle to signal an operator of a second vehicle. The first operator may transmit a notification signal via a first transceiver to a second transceiver associated with the second operator with a specific message, such as “stop.” When the second transceiver receives the notification signal, a visual indicator may be provided to the operator of the second vehicle. The second transceiver may also automatically transmit a confirmation signal upon receiving the notification signal. By receiving the notification signal, the first user may be informed that the notification signal was received by the second transceiver. By providing for a notification signal and an automated confirmation signal in response, the present system informs the first user the confidence that his transmitted signal was received. The present technology may be used for any type of vehicle, including all terrain vehicles (ATV), snow mobiles, jet skis, and other vehicles.

In some embodiments, the user of the first transceiver may select from a plurality of pre-set messages to transmit to the second user via the transceivers. The plurality of pre-set messages may include messages of “stop”, “come to my vehicle”, and “get help”. The visual indicators may provide an indication for each of the messages. For example, the transceivers may include an input for each message, a specific light emitting diode (LED) that illuminates upon receiving each status message, and a confirmation LED for each notification message. Alternatively, a single LED may be provided which illuminates in a unique pattern for each of the messages.

In some embodiments, the user of the second transceiver which receives the notification signal may transmit a second confirmation signal, in addition to the automatically transmitted notification signal, in response to receiving a confirmation input from the user that the user of the second transceiver has seen the visual indicator for the received notification signal. The second confirmation signal may communicate that the second user has actually seen the status message visual indicator. This may be prevent a situation where the notification signal is transmitted by a first user, the first and automatically transmitted confirmation signal is transmitted back in response, and the second user receives the confirmation signal when in fact the second user has not seen the visual indicator for the notification signal. This may occur because of visual indicator damaged or some other reason. Hence, when the first user receives the automatic confirmation signal and the user-initiated confirmation signal, the first user can be sure the second user has seen the visual indicator for the notification signal.

In some embodiments, the notification signal may be sent automatically. A transceiver may include an accelerometer which may detect when the ATV flips or experiences an abrupt deceleration or stop (such as after hitting a tree). When either a flip or an abrupt deceleration is experienced by the accelerometer, the accelerometer may trigger a signal to be sent by transceiver circuitry within a specific time period, such as one minute, unless the user of the ATV vehicle provides input to cancel the automatic transmission of a notification signal.

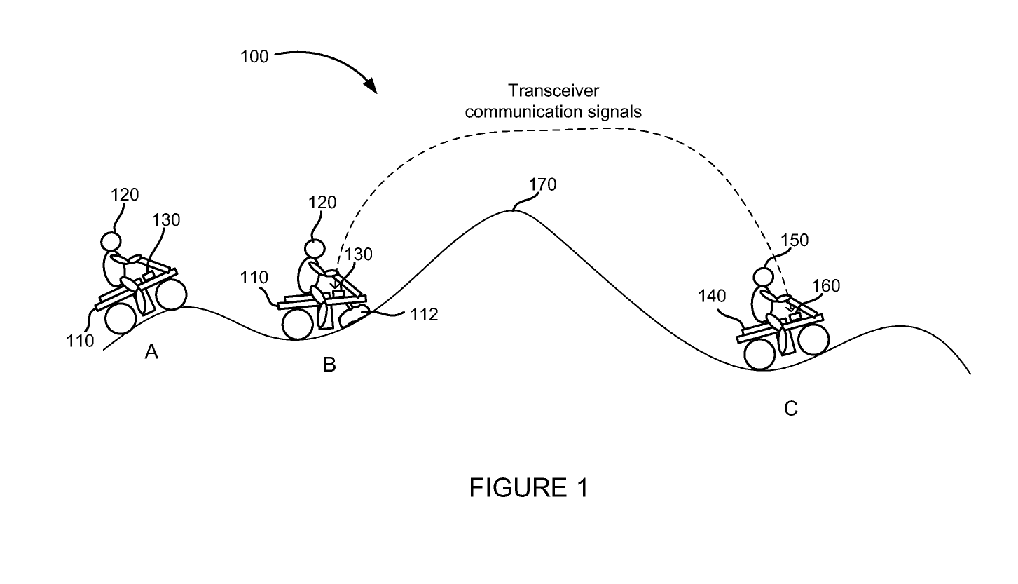

FIG. 1 illustrates an exemplary vehicle environment. The vehicle environment 100 of FIG. 1 includes a first all terrain vehicle (ATV) 110 and a second ATV 140. User 120 is operating ATV 110 and a user 150 is operating ATV 140. When user 120 of ATV 110 travels from position A to position B in environment 100, ATV 110 may experience a hazardous event, such as a flat tire (C 112), run out of gas, experience damage to the ATV, or experience some other event that requires the vehicle to stop or the user to operate the ATV with caution. User 120 on ATV 110 at position B may not be in a range of sight or sound with user 150 on ATV 140 at position C. This may be due to the distance between the two ATVs, an obstacle 170 between the users, such as a hill, or for some other reason. Using the present technology, user 120 may communicate with user 150 using transceivers 130 and 160 on vehicles 110 and 140, respectively. User 120 may initiate a notification signal from transceiver 130 on ATV 110 to transceiver 160 on ATV 140. Transceiver 160 may receive the notification signal, provide a visual indicator to user 150 that a signal was received, and automatically transmit a confirmation signal back to transceiver 130. This confirms to user 120 at ATV 110 that the notification signal transmitted was received by transceiver 160.

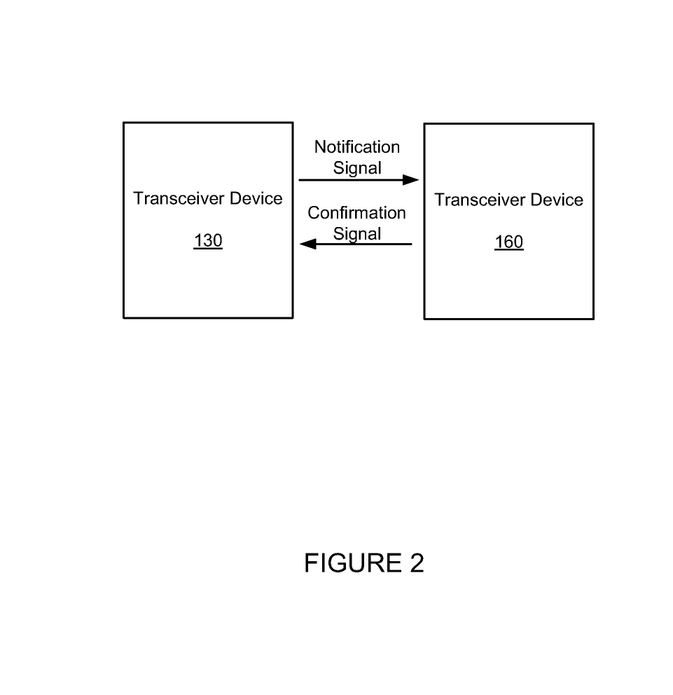

FIG. 2 is a block diagram of exemplary communications between two transceiver devices. As shown in FIG. 2, the transceiver device 130 may send a notification signal to transceiver device 160. Transceiver device 160 receives the notification signal and automatically transmits a confirmation signal back to transceiver 130. The notification signal sent by transceiver device 130 may be in response to user input or be sent automatically. The input may be a simple switch which indicates that the ATV 110 operated by user 120 has stopped or is in a hazardous situation. In some embodiments, the input may indicate a pre-set message indicating a desired action of another user (stop, come to my vehicle) or a condition of the vehicle associated with the transmitting transceiver (flat tire, damaged, stranded). Transceiver 160 may send a signal automatically in response to detecting a hazardous event for vehicle 110.

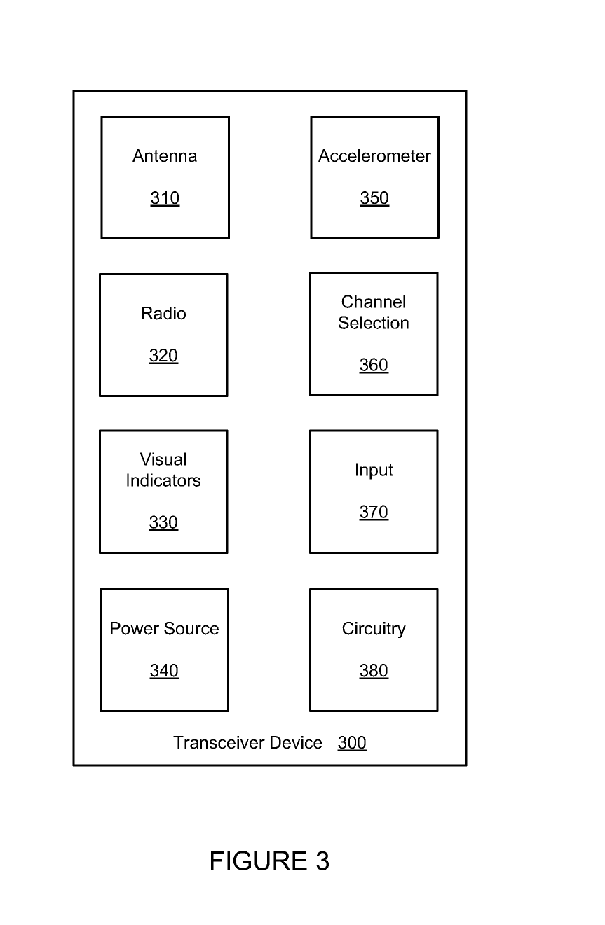

FIG. 3 is a block diagram of an exemplary transceiver device. Transceiver device 300 of FIG. 3 may provide more detail for transceivers 130 and 160 of FIG. 1. Transceiver device 300 includes antenna 310, radio 320, visual indicators 330, power source 340, accelerometer 350, channel selection module 360, inputs 370, and circuitry 380.

Antenna 310 may be coupled to radio 320 and may transmit and receive radio frequency (RF) signals. The transmitted signals may be generated by circuitry 380, provided to the antenna from radio 320, and may be broadcast through environment 100. The transmitted signals may be received by the transceiver attached to another ATV and associated with another user. Received signals may be received through antenna 310 and may be provided to radio 320.

Radio 320 may be coupled to antenna 310 and circuitry 380. Radio 320 may operate to provide transmission radio signals to the antenna received from circuitry 380 as well as provide received RF signals to circuitry 380 which are received from antenna 310.

Visual indicators 330 may include one or more LEDs for signaling information to a user of the ATV which the transceiver device is attached to. Visual indicators may include LEDs or other visual components having different sizes, colors, and functions. The visual indicators 330 may be controlled to illuminate based on RF signals sent and received by the transceiver device 300. For example, the visual indicators may include an LED indicating that a particular transmission was sent, an indicator that a particular transmission was received, and other information. There may be a plurality of LEDs such that one or more LEDs indicates a particular message (e.g., stop, come to my vehicle, flat tire, damaged ATV, message received, and so forth) was transmitted or received. Visual indicators 330 may also include a screen display, such as a liquid crystal display (LCD). The LCD may display information regarding a signal sent, a channel currently selected, current time and date, and other information regarding notification signals and confirmation signals.

Power source 340 may include one or more batteries, connections to a power source on an ATV, or other power source. Power source 340 may provide power to circuitry 380, visual indicators 330, and any other component of transceiver device 300 which requires power.

Accelerometer 350 may be coupled to circuitry 380 and/or visual indicators 340. The accelerometer may detect a degree of acceleration of deceleration along any of three axes. Accelerometer 350 may provide signals communicating a direction and magnitude of acceleration or deceleration to components which it is coupled to. For example, accelerometer 350 may detect that an ATV coupled to transceiver device 300 has flipped and may provide this information to circuitry 380. Accelerometer 350 may include any commercially available accelerometer.

Channel selection module 360 allows the user to select what radio frequency channel the transceiver device will communicate over. Typically, transceivers which communicate with each other are tuned to the same channel.

Input 370 may include one or more components which allow a user to provide input to transceiver device 300. The inputs may include, but are not limited to, a switch, button, touch screen, voice recognition system, or some other device. The input 370 may be associated with a particular notification, such as a switch for each of a flat tire condition, a stop status, a request another user to come to the location of transceiver device 300, or other data.

Circuitry 380 may include circuit components, integrated circuits and other parts for implement in the functionality described herein. For example, circuitry 380 may include a processor, resistors, relays, switches, capacitors, integrated circuits, and other components.

Transceiver device 300 may include additional components not illustrated in FIG. 3. For example, a transceiver device may include a global positioning service unit. The GPS unit may provide location information to circuitry 380 upon receiving a request for the current position of the transceiver device 300. For example, if a user provides input to send a notification signal to a user on another ATV requesting that the other user come to the position of the user of transceiver device 300, circuitry 380 may retrieve the current location of the transceiver device 300 from a GPS unit and transmit the GPS coordinates to the other transceiver.

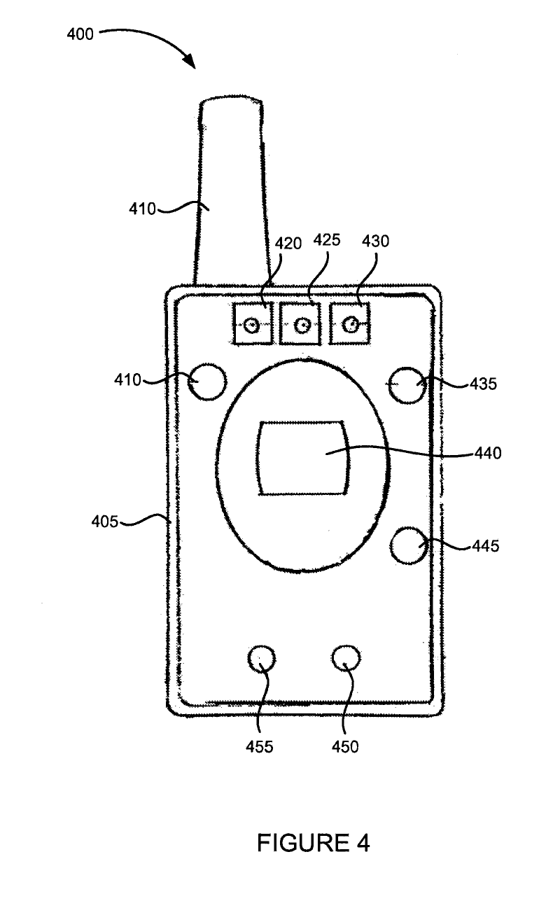

FIG. 4 is an exemplary receiver. The receiver of FIG. 4 includes a housing 405, an on/off switch 410, an antenna 415, visual indicators 420, 425 and 430, a channel up selector 435, a radio screen channel display 440, a channel down selector 445, a reset switch 450, and a signal send switch 455. Housing 405 may protect the inner components of transceiver 400 from external objects and the environment in which the transceiver is used. Radio mode and on/off switch 410 may be used to turn the transceiver on and off. Antenna 415 may be used to transmit and receive radio frequency antennas with other receivers and transmitters. Visual indicators 420-430 may include LEDs which may be illuminated based on notification signals transmitted and confirmation signals received by transceiver 400.

Channel selectors 435 and 445 may be used to change a current operating channel to a higher channel or lower channel, respectively. Radio screen 440 displays the current channel, as well as information regarding a signal transmitted or received by transceiver 400. Reset switch 450 rests the visual indicators to an off state. Signal send switch 455 may include one or more inputs which allow user to provide a selection regarding what type of signal to transmit by transceiver 400.

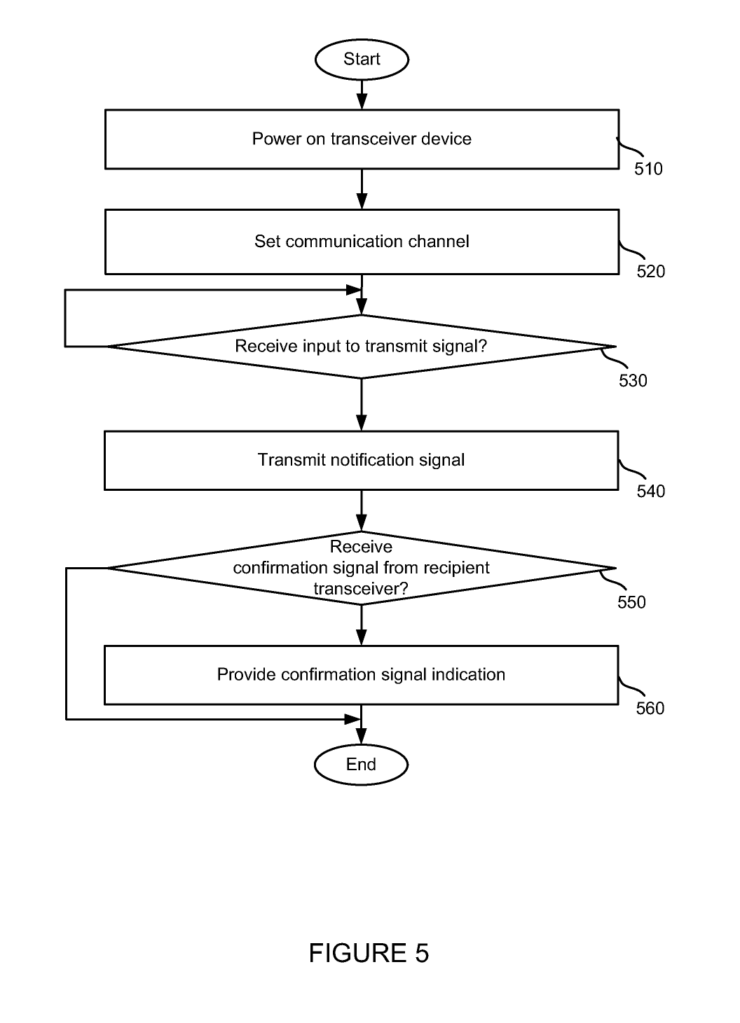

FIGS. 5-7 illustrate methods for performing functionality of exemplary invention embodiments. Each method steps may be optional and may be performed in a different order as illustrated in FIG. 5-7 and discussed herein.

FIG. 5 is a flow chart of an exemplary method for transmitting a notification signal by a transceiver from a first vehicle.

Power is applied to the transceiver device at step 510. The transceiver device may receive power from a battery within the transceiver, a power connection on the ATV or vehicle, or some other source. A communication channel may be set for the first vehicle transceiver at step 520. Typically, transceivers intended to communicate with each other and attached to different ATVs should be set to the same communication channel.

A determination is made as to whether an input is received to transmit a signal by the transceiver device at step 530. The determination may involve determining whether a notification in put is received from a user to send a notification signal. A user may provide input to notify another ATV user if the present user's ATV is damaged, not moving, if the user would like the user of another ATV to come to the current user, stop moving and stay in place, or some other notification. Hence, the input may be indicative of a requested action for another ATV user or a current status of the current ATV or ATV user. If no input is received to transmit a signal, the method of FIG. 5 remains at step 530.

Upon receiving input to transmit a signal at step 530, a notification signal is transmitted from the transceiver on the first vehicle at step 540. The transmission may be by the transceiver on a particular ATV and may indicate a particular input received by a user at step 530. In some embodiments, a signal transmission indication may be provided to a user by the transceiver which transmitted the message. The optional signal transmission indication may communicate to the user that the notification signal was successfully sent by the user's transceiver. This may prevent the user from falsely believing a communication is sent when in fact the transceiver is damaged, has low power, or for some other reason the transceiver does not actually transmit a notification signal.

A determination is made as to whether a confirmation signal is received from a recipient transceiver on a second vehicle at step 550. A confirmation signal is transmitted from another transceiver in response to receiving the notification signal sent by the present transceiver. If a confirmation signal is not received, the method of FIG. 5 ends. If the confirmation signal is received from another transceiver, a visual confirmation signal indication is provided at step 560. The visual indication may be the illumination of one or more LEDs (i.e., power applied to one or more LEDs), a message provided via an LCD screen, or some other indicator that a confirmation signal is received. In some embodiments, the confirmation signals and notification signals transmitted between receivers may have different encoding, frequencies, and other information to differentiate between the two signals by the transceivers.

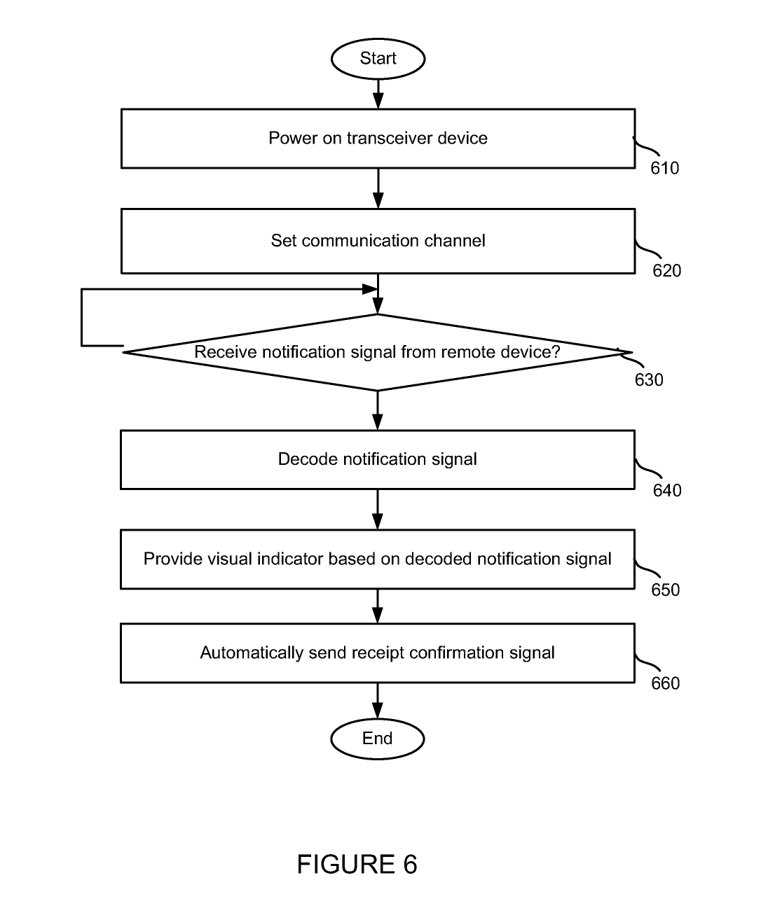

FIG. 6 is a flow chart of an exemplary method for sending a confirmation signal from a second vehicle. Power is provided to a transceiver device at step 610 and a communication channel is set for the transceiver device at step 620. A determination is then made as to whether a notification signal is received from a remote transceiver at step 630. The notification signal may be received from a transceiver on a remote ATV for which a user is trying to communicate something to a user of the current ATV having the current transceiver. If the notification signal is not received, the method of FIG. 6 remains at step 630.

If a notification signal is received, the notification signal may be decoded at step 640. The parameter value embedded within the signal may indicate a particular message the transmitting user intended to communicate. The parameter may be embedded using the frequency or magnitude of the received notification signal. The parameter value may correspond to a current status of the ATV or user or requested action of the current user.

A visual indicator is provided associated with the decoded signal at step 650. The visual indicator associated with the decoded signal may, for example, illuminate an LED based on the parameter decoded from the received notification signal. For example, the visual indicator may indicator that a user of a remote ATV is requesting the user of the present ATV stop his ATV. Alternatively, the notification signal may have a parameter which may be decoded to communicate that he user of the current ATV should return to the user of the other ATV.

In some embodiments, there may not be any parameter embedded into the notification signal. Rather, the notification signal may indicate that the user associated with the receiving transceiver should stop his or her ATV and wait for the user who transmitted the notification signal.

A confirmation signal is automatically sent at step 660. In some embodiments the confirmation signal is automatically transmitted by the current transceiver in response to receiving the notification signal.

In some embodiments, a second confirmation signal may be sent to indicate that a user of the receiving transceiver actually noticed and acknowledges the received notification signal. In this embodiment, the second confirmation signal may be sent in response to receiving input from the user of the second transceiver that the user has seen the notification visual indicator.

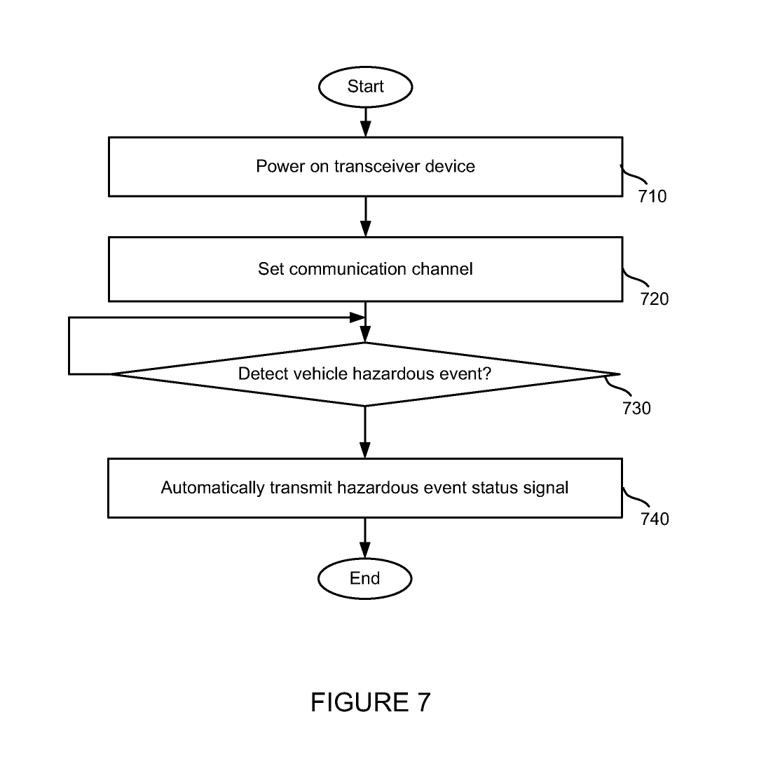

The method of FIG. 7 is a flow chart of an exemplary method for automatically transmitting a hazardous signal. Power is applied to a transceiver device at step 710 and a communication channel is set at step 720. A determination is then made as to whether a hazardous vehicle event is detected at step 730. In some embodiments, a user may not be able to send a notification signal if an event occurs that disables the user. For example, the ATV operated by the user may flip, crash, or the user may fall off and become injured and/or be separated from the hazardous vehicle. In this case, if a hazardous vehicle then is detected, the transceiver may automatically transmit a hazardous signal at step 740. The detection may be performed by an accelerometer, which triggers the circuitry of a transceiver to automatically transmit the hazardous signal.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for communicating a fixed signal, comprising:
receiving an input by a first transceiver associated with a first vehicle to transmit a notification signal;
transmitting the notification signal by the first transceiver;
receiving a confirmation signal from a second transceiver, the second transceiver associated with a second user of a second vehicle, the confirmation signal transmitted by the second transceiver in response to receiving the notification signal; and
providing a visual indicator by the first transceiver based on the confirmation signal.

2. The method of claim 1, wherein the first vehicle and the second vehicle are all terrain vehicles.

3. The method of claim 1, wherein the input is provided by a first user associated with the first vehicle.

4. The method of claim 1, wherein the input is generated by an accelerometer.

5. The method of claim 1, wherein the input includes receiving a notification selection.

6. The method of claim 5, wherein the notification selection indicates a requested action by the second user.

7. The method of claim 5, wherein the notification selection indicates a current status of the first vehicle.

8. The method of claim 1, further comprising providing an indication at the first transceiver that the notification signal was transmitted in response to transmitting the notification signal.

9. The method of claim 1, the visual indicator including a plurality of light emitting diodes(LEDs), wherein providing a visual indicator includes illuminating one or more selected LEDs of the plurality of LEDs based on the confirmation signal.

10. A transceiver for communicating a fixed signal, the system comprising:
an antenna configured to transmit and receive a radio frequency signal;
an input component configured to receive a user input;
a visual indicator; and
circuitry coupled to the antenna, input component, and the visual indicator, the circuitry configured to receive an input signal from the input component, encode a notification signal based on the received input signal, transmit the notification signal through the antenna, process a confirmation signal received through the antenna, and illuminate the visual indicator based on the received confirmation signal.

11. The transceiver of claim 10, further including an accelerometer, the circuitry further configured to automatically transmit the notification signal in response to detecting a hazardous vehicle event.

12. The transceiver of claim 10, the visual indicator including a plurality of LEDs, the circuitry further configured to determine a parameter value from the received confirmation signal and illuminate a selected LED of the plurality of LEDs based on the parameter value.

13. The transceiver of claim 10, wherein the transceiver is attached to an all-terrain vehicle.

14. The transceiver of claim 10, wherein decoding the radio signal includes detecting a parameter value embedded in the signal, the circuitry illuminating a selected visual indicator from a plurality of visual indicators based on the parameter value.

15. The transceiver of claim 10, the circuitry further configured to automatically generate a confirmation signal for transmission through the antenna in response to processing a notification signal received through the antenna.

16. A method for communicating a fixed signal, comprising:
receiving a notification signal by a first transceiver associated with a first vehicle from a second transceiver associated with a second vehicle;
illuminating an LED by the first transceiver in response to receiving the notification signal;
transmitting a confirmation signal by the first transceiver associated with a first vehicle to the second transceiver associated with a second vehicle.

17. The method of claim 16, wherein the first vehicle and the second vehicle are all terrain vehicles, the first transceiver mounted to the first all terrain vehicle and the second transceiver mounted to the second all terrain vehicle.

18. The method of claim 16, further comprising:
decoding the notification signal to determine a parameter value associated with a notification of the first vehicle; and
illuminating a selected LED of a plurality of LEDs based on the determined parameter value.

19. The method of claim 16, wherein the confirmation signal is transmitted automatically by the first transceiver in response to receiving the notification signal.

20. The method of claim 16, wherein the confirmation signal is transmitted by the first transceiver in response to receiving input from a user of the first vehicle.

21. A transceiver for communicating a fixed signal, the system comprising:
an antenna configured to transmit and receive a radio frequency signal;
an input component configured to receive a user input;
a visual indicator; and
circuitry coupled to the antenna, input component, and the visual indicator, the circuitry configured to decode a notification signal received from the antenna, illuminate the visual indicator based on the decoded notification signal, and provide an encoded confirmation signal to the antenna for transmission through the antenna.

22. The transceiver of claim 21, wherein the transceiver is attached to an all-terrain vehicle.

23. The transceiver of claim 21, wherein decoding the notification signal includes detecting a parameter value embedded in the notification signal, the circuitry illuminating a selected visual indicator from a plurality of visual indicators based on the parameter value.
